(19) United States
(12) Patent Application Publication
(10) Pub. No.: US 2026/0239238 A1
(43) Pub. Date: Aug. 13, 2026

(54) Synchronization Raster for Less Than 5MHz of Dedicated Spectrum

(71) Applicant: Apple Inc., Cupertino, CA (US)

(72) Inventors: Rolando E BETTANCOURT ORTEGA, Munich (DE); Jie CUI, San Jose, CA (US); Konstantinos SARRIGEORGIDIS, Los Gatos, CA (US); Manasa RAGHAVAN, Sunnyvale, CA (US); Qiming LI, Beijing (CN); Xiang CHEN, Palo Alto, CA (US); Yang TANG, San Jose, CA (US)

(21) Appl. No.: 19/156,008

(22) PCT Filed: Feb. 16, 2023
(86) PCT No.: PCT/CN2023/076471

§ 371 Date: Aug. 13, 2025

(51) Int. Cl. H04W 56/00; H04L 5/00; H04L 27/26

(52) U.S. Cl. CPC H04W 56/00; H04L 5/0007; H04L 27/2666

(57) ABSTRACT

A user equipment (UE) is configured to generate a synchronization raster comprising a plurality of synchronization raster points for a channel having a bandwidth that is less than 5 MHz based on a number of subcarriers in the channel (N), a frequency value (P) and a sub-carrier spacing (SCS) of the channel, wherein P is a frequency value of less than 1200 kHz and perform a synchronization operation comprising a raster search to acquire a synchronization signal block (SSB) based on the synchronization raster.

### BACKGROUND

Several areas of User Equipment (UE) behavior for synchronization of raster entries are in need of improvement. Specifically, improvements to UE and network behavior related to synchronization of raster entries for less than 5 MHz of dedicated spectrum are disclosed herein.

### SUMMARY

Some exemplary embodiments are related to a method performed by a user equipment (UE). The method includes generating a synchronization raster comprising a plurality of synchronization raster points for a channel having a bandwidth that is less than 5 MHz based on a number of subcarriers in the channel (N), a frequency value (P) and a sub-carrier spacing (SCS) of the channel, wherein P is a frequency value of less than 1200 kHz and performing a synchronization operation comprising a raster search to acquire a synchronization signal block (SSB) based on the synchronization raster.

Other exemplary embodiments are related to a user equipment (UE) having a transceiver configured to communicate with a base station and a processor communicatively coupled to the transceiver and configured to generate a synchronization raster comprising a plurality of synchronization raster points for a channel having a bandwidth that is less than 5 MHz based on a number of subcarriers in the channel (N), a frequency value (P) and a sub-carrier spacing (SCS) of the channel, wherein P is a frequency value of less than 1200 kHz and perform a synchronization operation comprising a raster search to acquire a synchronization signal block (SSB) based on the synchronization raster.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows a subcarrier grid according to various exemplary embodiments.

### DETAILED DESCRIPTION

The exemplary embodiments may be further understood with reference to the following description and the related appended drawings, wherein like elements are provided with the same reference numerals. The exemplary embodiments relate to improvements to UE and network synchronization of raster entries for less than 5 MHz of dedicated spectrum.

The exemplary embodiments are described with regard to a UE. However, reference to a UE is merely provided for illustrative purposes. The exemplary embodiments may be utilized with any electronic component that may establish a connection to an accessory device and is configured with the hardware, software, and/or firmware to exchange information and data with accessory devices. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to, future evolutions of the cellular protocol, or any other type of network.

The exemplary embodiments relate to UE and network operations for raster synchronization of less than 5 MHz of dedicated spectrum. Existing UE operations typically are in bandwidth allocations of more than 5 MHz. However, future implementation of NR (and future evolutions of the cellular standard) may support multiple low latency use cases resulting from various vertical industry domains, e.g., electrical power distribution grid, rail communication, etc. These uses cases often require less than the latency offered by legacy cellular standards (e.g., Long Term Evolution (LTE) technology). In some examples, Band 26 and Band 8 in the United States using 3 MHz wide channels have set a precedent of existing networks requiring a growth path to NR to meet the needs of utilities, the critical infrastructure industry (CII), and enterprise customers.

To provide some use case examples, it is expected that electric utilities may install smart grid systems and dedicated broadband spectrum to improve coverage, latency, and throughput to improve operations. These private systems will be a trusted and essential element for mission-critical communications to support autonomous smart grids. The ultra-low latency capabilities of NR may be used to meet the needs of CII.

In another use case example, rail communication in Europe is used for operational purposes to ensure the safety of millions of rail passengers. The Future Railway Mobile Communication System (FRMCS) forms the basis for digitizing rail operations with the aim of increasing train path utilization and improving punctuality. Currently, GSM-R requires a significant portion of the 4 MHz according to the GSM-R band definition. Consequently, possibilities in NR to operate in bandwidths less than 5 MHz (e. g., from around 3 MHz upwards) would enable parallel operation of FRMCS and GSM-R and massive infrastructure reuse. The provision of simultaneous use of the 2×5.6 MHz FDD in the 900 MHz frequency band and the associated provision of bandwidths less than 5 MHz for 5G NR thus has a key function in order to be able to start the migration from GSM-R to FRMCS in Europe. Thus, FRMCS may play a key role in the automation of rail operations. It is anticipated that this will lead to a significant improvement in route utilization and thus also contribute to the reduction of greenhouse gases.

For NR to operate in bandwidths less than 5 MHz, several areas of UE rasterization may be defined. It is preferable that synchronization raster entries should allow a UE to perform both system acquisition and measurements. One of skill in the art will recognize that in NR, Synchronization Signal Blocks (SSBs) do not need to be located in the center of a channel. Additionally, there is no longer a relationship between the SSB location and channel edges.

Different component carriers (CCs) may be on a same subcarrier grid (e.g., all the subcarriers may be processed by a single fast Fourier transform (FFT)). The number of entries for a synchronization raster may be calculated with the minimum channel bandwidth and the SS block bandwidth. The distance between the channel raster entries that CCs reside on should be a multiple of the subcarrier spacing (SCS).

As described above, existing UE operations typically are in bandwidth allocations of more than 5 MHz and there are definitions for synchronization raster entries for bandwidths greater than 5 MHz, e.g., 5 MHz−20 MHz. However, these synchronization raster entries are not sufficient for smaller bandwidths, e.g., 3 MHz. Thus, the exemplary embodiments are related to providing synchronization raster entries for bandwidths less than 5 MHz and operations that may be performed using these synchronization raster entries based on their relationship to the synchronization raster entries for the greater than 5 MHz bandwidths.

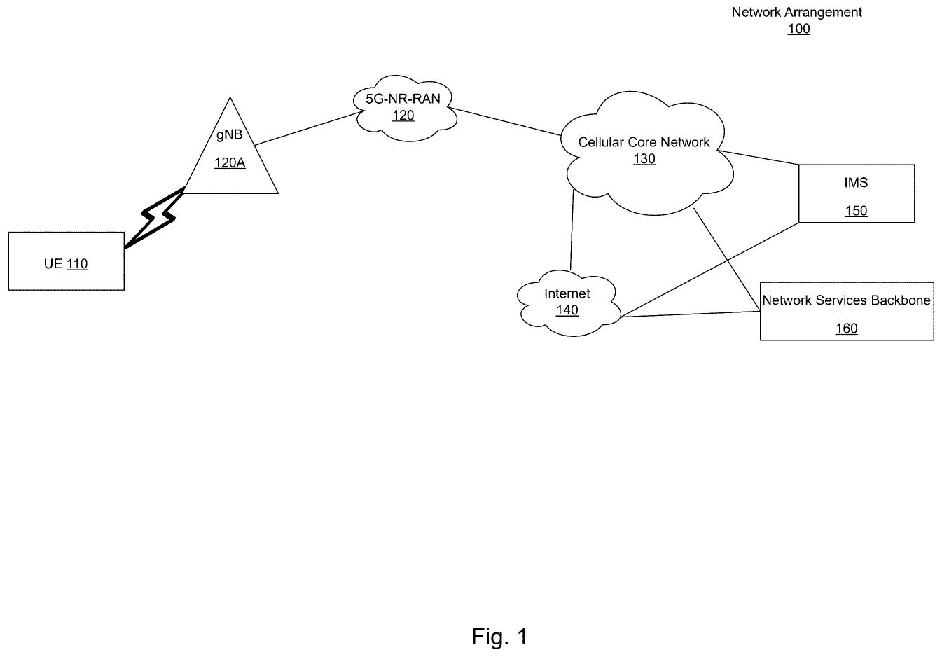

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of one UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

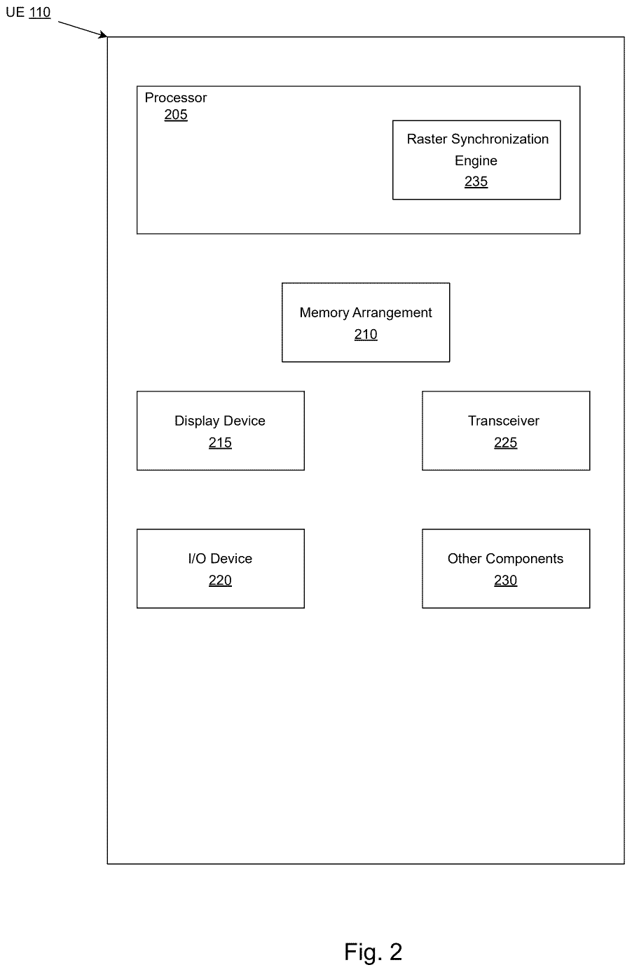

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a raster synchronization engine 235 for performing operations related to synchronization of raster entries for less than 5 MHz of channel bandwidth.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies).

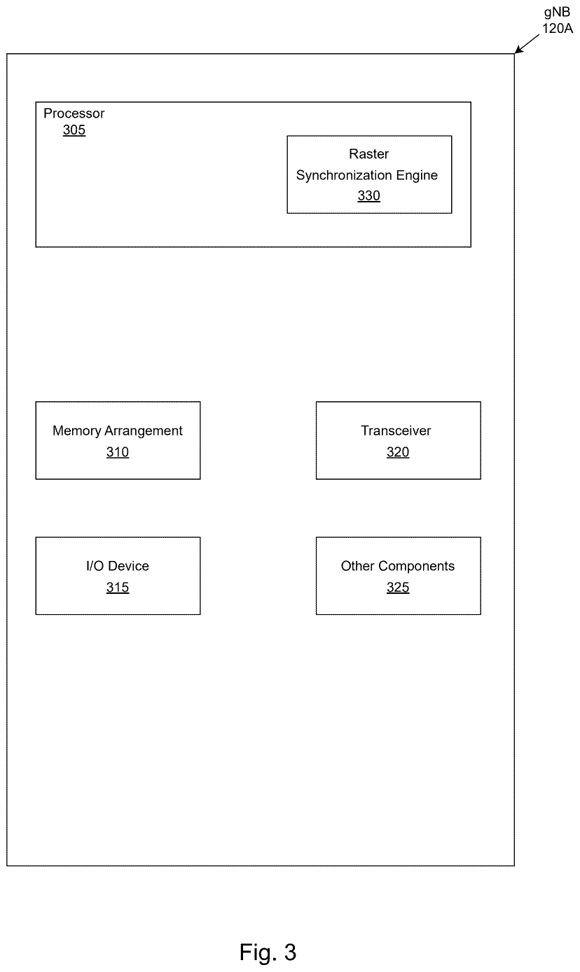

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a raster synchronization engine 330 for performing operations related to synchronization of raster entries for less than 5 MHz of channel bandwidth.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

In a first aspect of the exemplary embodiments, channel and SSB sizing for transmission bandwidths less than 5 MHz are disclosed. The exemplary embodiments will be described with respect to a 3 MHz channel by contrasting the 3 MHz channel with a currently defined 5 MHz channel. However, it should be understood that the use of a 3 MHz channel is only exemplary and the exemplary embodiments may be used with any channel having a bandwidth less than 5 MHz.

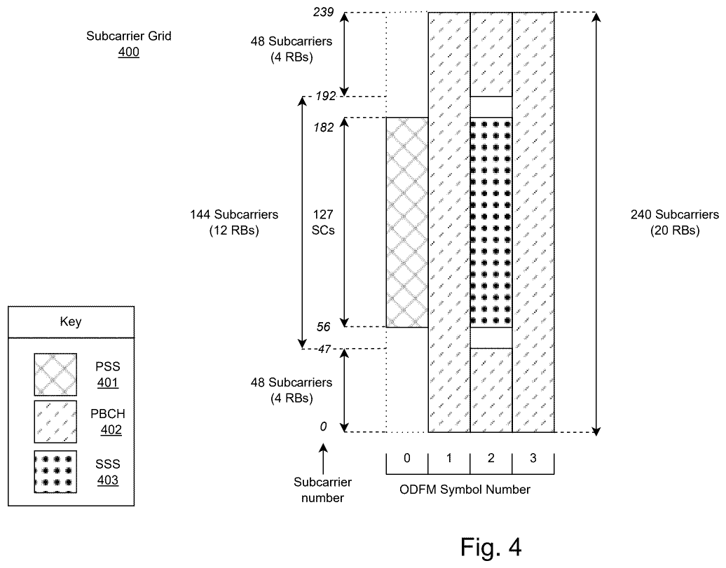

FIG. 4 shows a subcarrier grid 400 according to various exemplary embodiments. The subcarrier grid 400 may represent a synchronization signal block (SSB). The subcarrier grid 400 shows a primary synchronization signal (PSS) 401 in a first Orthogonal Frequency Division Multiplexing (OFDM) symbol and a secondary synchronization signal (SSS) 403 in a third OFDM symbol of the SSB. Each of the PSS and SSS have a size of 12 resource blocks (RBs) (including the sub-carrier spacing (SCS). The subcarrier grid 400 also shows physical broadcast channels (PBCH) 402 that are distributed in various OFDM symbols of the SSB. In total, the subcarrier grid 400 comprises 240 subcarriers, (e.g., 20 RBs).

A 5 MHZ channel would have 25 RBs. Thus, the example of FIG. 4 would be for a channel that is less than 5 MHz. However, the exemplary embodiments may be related to SSBs that have even smaller sizes, e.g., 12-16 RBs. It should be understood that 16 RBs would correspond to an channel of 3 MHz, meaning that the exemplary embodiments may be applicable to a channel size of 3 MHz or less. These sizes may be achieved by reducing the size of the PBCH 402 that are transmitted in the SSB as will be described in greater detail below.

Prior to describing manners of reducing the size of SSBs and calculating synchronization raster entries for channels less than 5 MHz, several variables may be defined. First, a minimum channel size (X) in RBs is defined. In the example of FIG. 4, the minimum channel size (X)=20. However, it should be understood that the minimum channel size (X) may be any value less than 5 MHz. An SSB size (Y) in RBs may be defined as being less than or equal to the minimum channel size in RBs (X). Moreover, the SSB size (Y) may also be defined as being greater than the PSS/SSS bandwidth (BW). This is because the PSS 401 and SSS 403 cannot be reduced in size. Thus, the relationship between X and Y is PSS/SSS BW≤Y≤X. In this example, it may be considered that regardless of the minimum channel size (X), the maximum SSB size (Y) may be defined as 16 RBs. Thus, since the PSS/SSS BW in this example is 12 RBs, SSB size (Y) may be understood as 12<Y≤16. Using these parameters, the following description provides examples of reducing the SSB size (Y).

In a first example, the SSB may be defined as only including enough RBs for the PSS 401 and SSS 403, e.g., Y=12 RBs, because the PSS 401 and SSS 403 cannot be reduced in size. Thus, the PBCH 402 will be reduced to 12 RBs that span the same frequency as the PSS 401 and SSS 403.

In a second example, the SSB may be defined as occupying an entire 3 MHz channel, e.g., Y=16 RBs. Thus, the PBCH 402 will be reduced to 16 RBs that span the frequency that includes the PSS 401 and SSS 403 but may also include RBs at frequencies above or below the frequencies that include the PSS 401 and SSS 403. For example, it may be considered that the PSS 401 and SSS 403 span 12 RBs and therefore for a 3 MHz channel, there are an additional 4 RBs. These 4 additional RBs for the PBCH 402 may all be at a higher frequency than the PSS 401 and SSS 403 RBs, may all be at a lower frequency than the PSS 401 and SSS 403 RBs or some of the 4 additional RBs may be at a higher frequency than the PSS 401 and SSS 403 RBs and some may be at a lower frequency than the PSS 401 and SSS 403 RBs (in any desired combination).

In a third example, the SSB may be defined as having between 12 and 16 RBs, e.g., Y=13−15. Referring to FIG. 4, achieving a channel of this size may be done in the same manner as was described above for the 3 MHz example, except with a different number of additional RBs.

As described above, there is no requirement that the PSS 401 and SSS 403 be in the center of the channel, so the UE may not know exactly where the PSS 401 and SSS 403 will be in the channel. As those skilled in the art will understand, synchronization raster entries are used by the UE to locate the PSS 401 and SSS 403 in the SSB.

An equation for raster generation may be N*P+M*50 kHz. M may be understood as a subchannel spacing and N may be understood as a number of subcarriers in the channel. The synchronization raster indicates the synchronization block frequency positions that may be used by a UE for system acquisition when explicit signaling of the SSB position is not present. In these examples, the value of P will be less than 1200 kHz. The exemplary embodiments provide several alternative equations to determine the value of P. After the value of P is determined, using, for example, one of the below equations, the formula N*P+M*50 kHz may be used to determine the synchronization raster.

A first exemplary equation to determine P may be defined as: 2*P−(P+250 kHz)≤Ceil{(X−Y)*(PRB in kHz)/Z)*Z. Each of the parameters in this equation were defined above, except Z that may be defined as the raster granularity. In these examples, Z=100 kHz. However, this is only exemplary and other values of Z may be used.

A second exemplary equation to determine P may be defined as: 2*P−(P+250 kHz)≤Ceil{(X−Y)*(PRB in kHz/Z}*Z+MCM(scs, Z). Again, each of the parameters in this equation were defined above, except MCM that is the minimum common multiple.

A third exemplary equation to determine P may be defined as: P=N*{Ceil(X−Y)*(PRB in kHz)/Z}*Z+MCM(scs, Z). To provide a specific example of this equation, it may be considered that the minimum bandwidth is 3 MHz, 15 PRBs are deployed in a channel (e.g., X=15), and SSB BW reduction is applied on a PBCH and the SSB BW after reduction is 12 PRBs (e.g., Y=12). Using the above third exemplary equation and the synchronization raster equation: P=N*{Ceil{3 PRB*180 kHz/100 kHz}*100 kHz+300 kHz}+M*50 kHz=N*900 kHz+M*50 kHz.

A fourth exemplary equation to determine P may be defined as: P=1200 kHz/D, where D is an integer greater than or equal to one.

After obtaining a synchronization raster, a UE may perform alternate behaviors based on whether the existing raster points for 5 MHz or larger channels are a subset of the newly generated 3 MHz synchronization raster.

In a first option, if the existing raster points (for channels 5 MHz or larger) are not a subset of a newly generated 3 MHz sync raster, the UE may not perform a blind detection operation for the SSB. Additionally, the UE may inform the network of its new synchronization raster, e.g., via Uplink Control Information (UCI), a Medium Access Control Control Element (MAC CE), Radio Resource Control (RRC) signaling, etc. The network may then inform one or more neighbor cells of the new synchronization raster during a handover operation.

When the existing raster points (for channels 5 MHz or larger) are not a subset of a newly generated 3 MHz sync raster, an equation to obtain an optimized synchronization raster may be: Ceil{(X−Y)/N}*N+MCM(scs,N)+K, where K is an optimization factor to allow for nested solution rasters between 3 MHz and the existing raster (for channels 5 MHz or larger).

A second option may apply when the existing raster points for channels 5 MHz or larger are a subset of a newly generated 3 MHz synchronization raster. UEs with improved raster support may search for both a 3 MHz raster and an existing raster. If a UE optionally supports 3 MHz and the UE does not support a 3 MHz channel, the UE may camp one or more access cell with channels equal to or larger than 5 MHz. Legacy UEs (e.g., those without 3 MHz support) may only search for an existing raster for channels 5 MHz or larger and may ignore newly added raster points.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE), comprising:
generating a synchronization raster comprising a plurality of synchronization raster points for a channel having a bandwidth that is less than 5 MHz based on a number of subcarriers in the channel (N), a frequency value (P) and a sub-carrier spacing (SCS) of the channel, wherein P is a frequency value of less than 1200 kHz; and
performing a synchronization operation comprising a raster search to acquire a synchronization signal block (SSB) based on the synchronization raster.

2. The method of claim 1, wherein the channel has a minimum channel size in Physical Resource Blocks (PRBs) (X), wherein the SSB is transmitted in the channel and has an SSB size (Y) in PRBs and wherein a raster granularity (Z) in frequency is defined.

3. The method of claim 2, wherein Y is less than or equal to X.

4. The method of claim 2, wherein Y is greater than or equal to a size in PRBs of a primary synchronization signal (PSS) or secondary synchronization signal (PSS) of the SSB.

5. The method of claim 2, further comprising:
determining P based on 2*P−(P+250 kHz)≤Ceil{(X−Y)*(PRB in kHz)/Z)*Z, wherein PRB in kHz is a size of a PRB in frequency.

6. The method of claim 2, further comprising:
determining P based on 2*P−(P+250 kHz)≤Ceil{(X−Y)*(PRB in kHz/Z}*Z+MCM(scs, Z), where MCM is a minimum common multiple in frequency, and SCS is a subcarrier spacing.

7. The method of claim 2, further comprising:
determining P based on P=N*{Ceil(X−Y)*(PRB in kHz)/Z}*Z+MCM (scs, Z).

8. The method of claim 2, further comprising:
determining P based on P=1200 kHz/D, wherein D is an integer greater than or equal to one.

9. The method of claim 1, further comprising:
determining existing synchronization raster points for a channel greater than 5 MHz are not a subset of the synchronization raster points of the synchronization raster, wherein the synchronization operation omits performing blind detection for the SSB.

10. The method of claim 9, further comprising:
transmitting the synchronization raster points of the synchronization raster to a network.

11. The method of claim 2, further comprising:
generating an updated synchronization raster comprising an updated plurality of synchronization raster points based on Ceil{(X−Y)/N}*N+MCM(scs,N)+K, where K is an optimization factor, N is a number of subcarriers, MCM is a minimum common multiple, and SCS is a subcarrier spacing,
wherein existing synchronization raster points for a channel greater than 5 MHz are a subset of the updated synchronization raster points of the updated synchronization raster.

12. The method of claim 11, wherein the synchronization operation comprises:
performing a raster search operation for both the channel having a frequency of less than 5 MHz and the channel having a frequency greater than 5 MHz.

13. A user equipment (UE), comprising:
a transceiver configured to communicate with a base station; and
a processor communicatively coupled to the transceiver and configured to:
generate a synchronization raster comprising a plurality of synchronization raster points for a channel having a bandwidth that is less than 5 MHz based on a number of subcarriers in the channel (N), a frequency value (P) and a sub-carrier spacing (SCS) of the channel, wherein P is a frequency value of less than 1200 kHz; and
perform a synchronization operation comprising a raster search to acquire a synchronization signal block (SSB) based on the synchronization raster.

14. The UE of claim 13, wherein the channel has a minimum channel size in Physical Resource Blocks (PRBs) (X), wherein the SSB is transmitted in the channel and has an SSB size (Y) in PRBs and wherein a raster granularity (Z) in frequency is defined.

15. The UE of claim 14, wherein Y is less than or equal to X.

16. The UE of claim 14, wherein Y is greater than or equal to a size in PRBs of a primary synchronization signal (PSS) or secondary synchronization signal (PSS) of the SSB.

17. The UE of claim 13, wherein the processor is further configured to:
determine existing synchronization raster points for a channel greater than 5 MHz are not a subset of the synchronization raster points of the synchronization raster, wherein the synchronization operation omits performing blind detection for the SSB.

18. The UE of claim 13, wherein the processor is further configured to:
transmit the synchronization raster points of the synchronization raster to a network.

19. The UE of claim 14, wherein the processor is further configured to:
generate an updated synchronization raster comprising an updated plurality of synchronization raster points based on Ceil{(X−Y)/N}*N+MCM(scs,N)+K, where K is an optimization factor, N is a number of subcarriers, MCM is a minimum common multiple, and SCS is a subcarrier spacing,
wherein existing synchronization raster points for a channel greater than 5 MHz are a subset of the updated synchronization raster points of the updated synchronization raster.

20. The UE of claim 19, wherein the synchronization operation comprises:
performing a raster search operation for both the channel having a frequency of less than 5 MHz and the channel having a frequency greater than 5 MHz.
